(19) United States
(12) Patent Application Publication
(10) Pub. No.: US 2003/0080479 A1
(43) Pub. Date: May 1, 2003

(54) Method of forming Sarira

(76) Inventor: Chingsung Su, Taipei City (TW)

Correspondence Address: Chingsung SU, P.O. Box 82-144, TAIPEI, TW

(21) Appl. No.: 09/984,044

(22) Filed: Oct. 26, 2001

(51) Int. Cl. C04B 33/32

(52) U.S. Cl. 264/669; 264/674

(57) ABSTRACT

A method of forming Sarira is disclosed. The present method employs bone ash being introduced to a melting aid to form phosphate ceramic material.

### BACKGROUND OF THE INVENTION

(a) Technical Field of the Invention

The present invention relates to a method of forming Sarira, and in particular, a method of forming phosphate ceramic material by employing bone ash being introduced to a melting aid.

(b) Description of the Prior Art

Sarira is a Sanskrit word literally means “body’, but in Buddhist usage most often refers to the sacred relics found in cremated remains of the Buddha or of a Buddhist monk. Often in the cremated remains of monks who have led extremely pure lives are round Sarira of various colors and sizes that look like effulgent pearls.

From the viewpoint of science, bone and skeleton is product of biological minerals. Bone cells abstract phosphate and calcium from food to form bone, and the major component of bone is calcium phosphate. Based on researches, the requirement for the formation of Sarira is the burning of bone with wood fire and with sufficient crystallization process. Accordingly, it is an object of the present invention to provide a method of forming Sarira.

### SUMMARY OF THE INVENTION

Accordingly, an object of the present invention is to provide a method of forming Sarira, wherein bone ash is introduced to a melting aid to form phosphate ceramic material.

An aspect of the present invention is to provide a method of forming Sarira comprising the steps of mixing bone ash with a melting aid to form a blank; and sintering the blank at a temperature ranging from 1100 to 1300 deg Celsius.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

In accordance with the present invention, the conditions for the formation of sarira are: burning within an implementable temperature range; mixing of bone ash with ash of wood; and sufficient burning.

The wood ash contains large amount of alkaline materials such as potash soda, silica, and trace of magnesium, iron and phosphorous. The potassium, sodium, magnesium and phosphorus of the wooden ash provide efficient aid in melting, and therefore, this plays an important role in the formation of Sarira.

The components of the bone ash are:

Calcium phosphate: 67-85%,

Magnesium carbonate: 3-10%

Magnesium phosphate: 2-3%

Caustic soda: slight

Calcium fluoride: slight

With the help of the melting aid components within the wooden ash, the temperature range of the buming wood allows the sintering process to take place, and in actual fact, the temperature of burning wood is around 1230-1250 degree Celsius.

In a preferred embodiment of the present invention, the melting aid has the following components:

“Kinmen” soil: 10%

ball-like clay: 20%

white mica: 40%

long stone: 15%

calcium oxide: 15%

These components have the advantages of melting assistance and formation, and based on different mixed ratio of the bone ash, a Sarira is obtained under a sintering temperature of 1210 to 1230° C. for a sintering time of 40 minutes. The percentage of bone ash decreases by 10 progressively, and it is found out that the best result of the Sarira is at 40 to 60% of the bone ash. Of course, the temperature range can be changed, for instance, if the amount of bone ash increases, the temperature has to be increased in order to provide the best result.

The melting aid of the present invention disclosed in the present application does not limited to the above. Other type of implementable melting aid can be used so as to simulate the formation of Sarira. The potassium and calcium in the long stone of the melting aid can be obtained abundantly, and the white mica contains calcium and magnesium and the “Kinmen” soil and the ball-like clay facilitate the formation of blank. If this sort of formation is not essential, this component can be avoided.

In accordance with the present invention, the formation of Sarira by way of, for example, kneading, molding, graving, ornamenting, etc

In accordance with the present invention, the advantages of Sarira are that

(1) The sintered body formed from bone ash is solid and stable, and therefore, this provides a way of keeping bone ash.

The sintered body provides an aesthetic appearance with respect to color, and patterns.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of forming Sarira comprising the steps of:
mixing bone ash with a melting aid to form a blank; and
sintering the blank at a temperature ranging from 1100 to 1300 deg Celsius.

2. The method of claim 1, wherein the bone ash is selected from the remains of human bone and of pets.

3. The method of claim 1, wherein the melting aid contains wooden/ash of potassium, sodium, calcium or magnesium as main components.

4. The method of claim 1, wherein the melting aid is selected from the group consisting of mixed blank material of “Kinmen” soil, ball-like clay, white mica, long stone and calcium oxide.

5. The method of claim 1, wherein the scope of sintering temperature is ranging from 1210 to 1230 degree Celsius.

6. The method of claim 1, wherein the sintering process is performed under an oxidation or reduction environment.

7. The method of claim 1, wherein the weight ratio of the bone ash to the blank is preferably between 30-80%.

8. A method of forming Sarira comprising the steps of mixing bone ash of the remains of human bone or of pets to form a blank and sintering the blank at a temperature ranging from 1210 to 1230 degree Celsius under oxidation or reduction condition form phosphates and silicates mixed sintered body, wherein the components of the melting aid are as follows:
“Kinmen” soil: 10%, ball-like clay: 20%, white mica: 40%, long stone: 15% and calcium oxide: 15%, and the weight ratio of the bone ash to the blank is between 30-80%.
